(19) United States
(12) Patent Application Publication
(10) Pub. No.: US 2024/0171997 A1
(43) Pub. Date: May 23, 2024

(54) MECHANISM FOR DELIVERING BEAM INFORMATION

(71) Applicant: Nokia Technologies Oy, Espoo (FI)

(72) Inventors: Lei DU, Beijing (CN); Lars DALSGAARD, Oulu (FI); Yueji CHEN, Hangzhou (CN); Chunli WU, Beijing (CN); Karri Markus RANTA-AHO, Espoo (FI)

(21) Appl. No.: 18/552,783

(22) PCT Filed: Apr. 26, 2021
(86) PCT No.: PCT/CN2021/090040

§ 371 Date: Sep. 27, 2023

(51) Int. Cl. H04W 16/28; H04B 17/318; H04W 74/00; H04W 74/0833

(52) U.S. Cl. CPC H04W 16/28; H04B 17/328; H04W 74/006; H04W 74/0833

(57) ABSTRACT

According to embodiments of the present disclosure, when an unknown secondary cell configured with a physical uplink control channel is activated, a terminal device determines whether to transmit beam information to a network. The terminal device receives a physical downlink control channel (PDCCH) order in a beam which is selected in association with the beam information. In this way, a proper beam can be determined to transmit PDCCH order and it can also reduce delay.

### FIELD

Embodiments of the present disclosure generally relate to the field of telecommunication and in particular, to methods, devices, apparatuses and computer readable storage medium for delivering beam information.

### BACKGROUND

With development of communication technologies, it requires larger communication capacity. In some scenarios, a terminal device can be configured with a plurality of cells. For example, carrier aggregation (CA) is proposed. CA is a technique used in wireless communication to increase a data rate per user or extend the coverage, where multiple component carriers are configured to a same user. In Carrier Aggregation (CA), two or more Component Carriers (CCs) are aggregated. A UE may simultaneously receive or transmit on one or multiple CCs depending on its capabilities. A component carrier is referred to as a serving cell and it is treated as such by higher layers. In frequency division duplex (FDD), a serving cell comprises a pair of different downlink and uplink carrier frequencies, while in time division duplex (TDD) a single carrier frequency is used with downlink and uplink transmissions in different time intervals.

### SUMMARY

The scope of protection sought for various embodiments of the invention is set out by the independent claims. The [embodiments/examples] and features, if any, described in this specification that do not fall under the scope of the independent claims are to be interpreted as examples useful for understanding various embodiments of the invention.”

Please note that the term “embodiments” or “examples” should be adapted accordingly to the terminology used in the application, i.e. if the term “examples” is used, then the statement should talk of “examples” accordingly, or if the term “embodiments” is used, then the statement should talk of “embodiments” accordingly.

In general, example embodiments of the present disclosure provide a solution for delivering beam information.

In a first aspect, there is provided a first device. The first device comprises at least one processor; and at least one memory including computer program codes; the at least one memory and the computer program codes are configured to, with the at least one processor, cause the first device to receive, from a second device, an activation indication to activate a second cell of a third device; determine whether beam information of the second cell needs to be transmitted to the second device on a first cell; and receive a physical downlink control channel order from the third device to perform a random access procedure to the third device.

In a second aspect, there is provided a second device. The second device comprises at least one processor; and at least one memory including computer program codes; the at least one memory and the computer program codes are configured to, with the at least one processor, cause the second device to transmit, at a second device and to a first device, an activation indication to activate a second cell of a third device; transmit, to the first device, information indicating a resource in a first cell of the second device for transmitting beam information of a second cell of a third device by the first device; and receive, from the first device, the beam information of the second cell of the third device on the first cell.

In a third aspect, there is provided a third device. The third device comprises at least one processor; and at least one memory including computer program codes; the at least one memory and the computer program codes are configured to, with the at least one processor, cause the third device to transmit, at a third device and to a first device, a physical downlink control channel order on a second cell of the third device in at least one beam which is selected in association with beam information of the second cell; and receive, from the first device, channel state information on the second cell.

In a fourth aspect, there is provided a method. The method comprises receiving, at a first device and from a second device, an activation indication to activate a second cell of a third device; determining whether beam information of the second cell needs to be transmitted to the second device on a first cell of the second device; and receiving a physical downlink control channel order from the third device to perform a random access procedure to the third device.

In a fifth aspect, there is provided a method. The method comprises transmitting, at a second device and to a first device, an activation indication to activate a second cell of a third device; transmitting, to the first device, information indicating a resource in a first cell of the second device for transmitting beam information of a second cell of a third device by the first device; and receiving, from the first device, the beam information of the second cell of the third device on the first cell.

In a sixth aspect, there is provided a method. The method comprises transmitting, at a third device and to a first device, a physical downlink control channel order in at least one beam which is selected in association with beam information of the second cell; and receiving, from the first device, channel state information on the second cell.

In a seventh aspect, there is provided an apparatus. The apparatus comprise means for receiving, at a first device and from a second device, an activation indication to activate a second cell of a third device; means for determining whether beam information of the second cell needs to be transmitted to the second device on a first cell of the second device; and means for receiving a physical downlink control channel order from the third device to perform a random access procedure to the third device.

In an eighth aspect, there is provided an apparatus. The apparatus comprises means for transmitting, at a second device and to a first device, an activation indication to activate a second cell of a third device; means for transmitting, to the first device, information indicating a resource in a first cell of the second device for transmitting beam information of a second cell of a third device by the first device; means for and receiving, from the first device, the beam information of the second cell of the third device on the first cell.

In a ninth aspect, there is provided an apparatus. The apparatus comprises means for transmitting, at a third device and to a first device, a physical downlink control channel order in at least one beam which is selected in association with beam information of the second cell; and means for receiving, from the first device, channel state information on the second cell.

In a tenth aspect, there is provided a computer readable medium. The computer readable medium comprises program instructions for causing an apparatus to perform at least the method according to any one of the above fourth, fifth, or sixth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling flow for delivering beam information according to some example embodiments of the present disclosure;

FIG. 3 illustrates a signaling flow for delivering beam information according to other example embodiments of the present disclosure;

FIG. 4 illustrates a flowchart of a method implemented at a first apparatus according to some example embodiments of the present disclosure;

FIG. 5 illustrates a flowchart of a method implemented at a second apparatus according to some other example embodiments of the present disclosure;

FIG. 6 illustrates a flowchart of a method implemented at a third apparatus according to some other example embodiments of the present disclosure;

FIG. 7 illustrates a simplified block diagram of an apparatus that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure.

Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/ or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated and Access Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. The term “terminal device” refers to any end device that may be capable of wireless communication. In the following description, the terms “terminal device”, “terminal”, “user equipment” and “UE” may be used interchangeably.

As mentioned above, a terminal device configured with CA has at least a serving cell and it is referred to as a primary cell (PCell) or a primary secondary cell (PSCell) and/or other serving cells are called secondary cell (SCell). With a radio resource control (RRC) connection on the PCell, a network device can further configure one or more SCells for the terminal device. According to some conventional technologies, PCell can be configured with PUCCH which is used for uplink control signaling transmission. In order to improve capacity, in LTE system, 3GPP has introduced SCell configured with UL including physical uplink control channel (PUCCH). This SCell is named PUCCH SCell. Same principle applies also to PSCell if CA is configured on SCG.

In new radio (NR), as in long term evolution (LTE), a SCell can be activated or deactivated or dormant. Based on the activation/deactivation mechanism of Scells defined, the goal is to enable reasonable UE battery consumption when CA is configured. When a SCell is deactivated, the UE does not need to receive the corresponding physical downlink control channel (PDCCH) or physical downlink shared channel (PDSCH) and cannot transmit in the corresponding uplink. The UE is not required to perform layer 1/layer 2 (L1/L2) measurements, for example, channel state information (CSI) measurements on the SCell. The UE is still required to perform radio resource management (RRM) measurements in a deactivated SCell with relaxed performance. Conversely, when a SCell is active, the UE shall receive PDSCH and PDCCH (if the UE is configured to monitor PDCCH from this SCell) and is required to be able to perform L1 measurements, such as, CSI measurements and report those as configured.

The transitions between activated and deactivated statuses are mainly based on medium access control (MAC) control element (CE) commands from the network. For instance, the SCell activation/deactivation MAC CEs are proposed to indicate if the SCell with SCell Index i shall be activated or deactivated.

When the UE activates a deactivated SCell, it takes time i.c. activation delay, which is composed of multiple part including T_{activation_time}, to transit from a deactivated status to an activated status. The requirements for the activation delay within which the UE shall be able to activate a deactivated SCell have been proposed. Generally, the single SCell activation delay requirement for the UE configured with one downlink SCell (non-PUCCH SCell) i.c. T_{activation_time} is defined as

$$\frac{{T}_{HARQ} + {T}_{activation \_ time} + {T}_{CSI \_ Reporting}}{NR slot length}$$

in unit of slots.

While activating the PUCCH SCell (i.e. the SCell which is configured with PUCCH), the difference from activation of downlink only SCells (i.e. SCells without PUCCH) is that the UE may need to ‘activate uplink’ in addition to the downlink actions. Typically, if the UE has no valid timing advance (TA) on the PUCCH SCell at cell activation, the network shall send PDCCH order to the UE to trigger the UE to initiate a random access to the PUCCH SCell. The UE then performs random access after acquiring downlink timing (after downlink activation delay) and having received the PDCCH Order to acquire the uplink timing/synchronization in the PUCCH SCell. Once the UE has received the UL timing alignment (TA) from the network, the UE would be able to transmit a valid CSI report on the PUCCH SCell which indicates that the SCell is considered as activated.

In LTE, when the network sends the PDCCH order is up to network implementation. The activation delay requirement is defined assuming the UE has received a PDCCH order within the activation period of downlink actions. That is, the UE has received a PDCCH order to initiate random access (RA) procedure on the PUCCH SCell within T_{activate_basic} otherwise additional delay to activate the SCell is expected. It is also assumed that the RA on PUCCH SCell is not interrupted by any RA on PCell in which case an additional delay to activate the SCell is allowed. No sounding reference signal (SRS) carrier based switching occurs during the SCell activation procedure otherwise the PUCCH SCell activation delay (T_{delay_PUCCH SCell}) can be extended.

In NR, beamforming has been widely assumed i.e. the UE is assumed using UE receiving/transmitting (Rx/Tx) beam forming and supposed to monitor specific DL beam(s) when receiving PDCCH/PDSCH from the network. Additionally, it may also transmit on certain uplink (UL) beam(s) to the network. Especially for higher frequency ranges, e.g. frequency range 2 (FR2), RX/TX UE beam forming is seen important to ensure the link budget. Similarly, in higher frequency ranges, e.g. in FR2, the signals are as baseline transmitted e.g. from gNB with beam forming instead of in omni-directional manner. Similarly it is assumed that in higher frequencies like e.g. FR2 UEs will not be receiving in an omni-directional manner as assumed in legacy in lower frequency ranges and e.g. FR1. The term “frequency range 2 (FR2)” used herein can refer to a frequency range from 24.25 GHz to 52.6 GHZ. The term “frequency range 1 (FR1)” used herein can refer to a frequency range from 4.1 GHZ to 7.125 GHZ. The definition of FRI and FR2 are up to 3GPP discussion. In general, when used herein, FR1 refer to lower frequency ranges while FR2 refer to higher frequency ranges. Higher and lower frequency ranges should be understood in broad manner and need not be limited to FR2 and FR1.

When applying beam forming and beam formed transmission in gNB, when activating the PUCCH SCell, the network may need to know the beam information i.c. synchronization signal block (SSB) index on which to transmit the PDCCH order to trigger the random access, so that the UE can receive the PDCCH Order and transmit the RA preamble on the PRACH occasions/resources associated with the SSB index. The term “SSB” used herein refers to a block carries a primary synchronization signal (PSS), a secondary synchronization signal (SSS) and a physical broadcast channel (PBCH).

Up to now, the network needs to know the DL beam information for transmitting the PDCCH order to trigger the RA procedure. The beam information is normally indicated to the gNB in the measurement report via SSB index (e.g. for rough beams) or CSI-RS resource index (e.g. for refined beams). The UE can be configured (by the gNB) to perform the beam-specific RRM measurements and deliver the beam information to the network via the measurement report.

According to some conventional technologies, the SCell is considered as known or unknown based on if the UE has sent a valid measurement report with beam Index information within a certain time period. If the network has received such beam-specific measurement reports within a certain time period for the SCell to be activated, the network can determine and assume that downlink (DL) beam associated with the SSB index (based on the received L3 measurement report) is valid and hence the UE does not need to acquire further beam information when SCell is activated. Otherwise, if the SCell to be activated is unknown, the network cannot assume to have valid DL beam information of the PUCCH SCell when activating the SCell. Hence, in such case the network would not have accurate information on the DL beam associated to a measurement report with a given SSB Index, on which it can reach the UE. In some cases, the UE need to explicitly indicate the beam information to the network during the activation period.

SCell in FRI is known if it has been meeting the following conditions: during the period equal to max(5*measCycleSCell, 5*DRX cycles) for FR1 before the reception of the SCell activation command: the UE has sent a valid measurement report for the SCell being activated and the SSB measured remains detectable according to the cell identification conditions; the SSB measured during the period equal to max(5*measCycleSCell, 5*DRX cycles) also remains detectable during the SCell activation delay according to the cell identification conditions. Otherwise SCell in FR1 is unknown.

For the first SCell activation in FR2 bands, the SCell is known if it has been meeting the following conditions: during the period equal to 4s for UE supporting power class1 and 3s for UE supporting power class 2/3/4 before UE receives the latest activation command for PDCCH transmission configuration indicator (TCI), PDSCH TCI (when applicable) and semi-persistent channel state information-reference signal (CSI-RS) for channel quality indicator (CQI) reporting (when applicable): the UE has sent a valid layer 3-reference signal received power (L3-RSRP) measurement report with synchronization signal block (SSB) index; SCell activation command is received after L3-RSRP reporting and no later than the time when UE receives MAC-CE command for TCI activation; during the period from L3-RSRP reporting to the valid CQI reporting, the reported SSBs with indexes remain detectable according to the cell identification conditions, and the TCI state is selected based on one of the latest reported SSB indexes.

However, for transmitting in a cell the UE will need to have uplink timing synchronization and hence a valid TA value. Additionally, transmitting the beam information in the PUCCH SCell requires uplink resources which may not be available on the PUCCH SCell to be activated. The UL resources in PUCCH SCell cannot be used for transmission until the UE has acquired the uplink timing i.e. after the completion of RA procedure. According to conventional technologies, it may consider the case of transmitting CSI report on PUCCH PCell, which implies using PUCCH of PCell for transmitting the beam information. But this conflicts with the definition of PUCCH SCell where PUCCH is allowed to be configured only on either PCell/PSCell or PUCCH SCell.

According to conventional technologies, the PUCCH for the PUCCH SCell is configured at SCell reconfiguration (when the SCell is configured); changing PUCCH configuration requires RRC signaling which takes long time and may impact the other SCells associated with the PUCCH SCell. On the other hand, the beam information is to be delivered during the activation period. Changing the PUCCH configuration via RRC messages may further extend the SCell activation delay hence degrades the system performance.

Therefore, it is expected to study the solutions to minimize the beam information transmission to avoid the signaling overhead and the negative impact to activation delay. Meanwhile, the fast solution to deliver the beam information if necessary needs to be elaborated. Additionally, a solution which is backwards compatible is needed.

According to embodiments of the present disclosure, when an unknown PUCCH SCell is activated, a terminal device determines whether to transmit beam information to a network. The terminal device receives a PDCCH order in a beam which is selected in association with the beam information. In this way, a proper beam can be determined to transmit PDCCH order and it can also reduce delay.

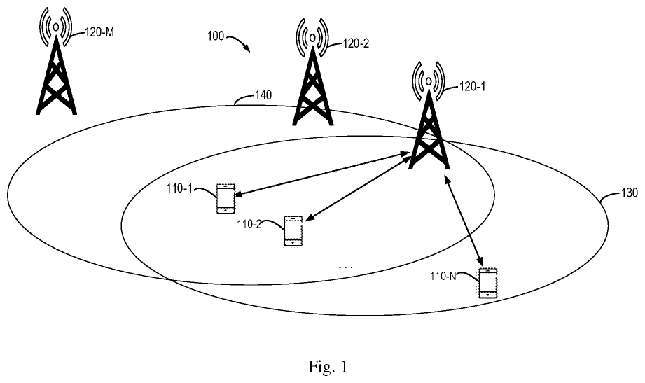

FIG. 1 illustrates a schematic diagram of a communication environment 100 in which embodiments of the present disclosure can be implemented. The communication environment 100, which is a part of a communication network, further comprises a device 110-1, a device 110-2. . . , a device 110-N, which can be collectively referred to as “first device(s) 110.” The communication environment 100 comprises a device 120-1, a device 120-2, . . . , a device 120-M, which can be collectively referred to as “device(s) 120.” The number N and the number M can be any suitable integer numbers.

The communication environment 100 may comprise any suitable number of devices and cells. In the communication environment 100, the first device 110 and the device 120 can communicate data and control information to each other. In the case that the first device 110 is the terminal device and the device 120 is the network device, a link from the device 120 to the first device 110 is referred to as a downlink (DL), while a link from the first device 110 to the device 120 is referred to as an uplink (UL). The device 120 and the first device 110 are interchangeable. The first device 110 can be configured with more than one cell. Only for the purpose of illustrations, the first device 110 can be configured with a first cell 130 and a second cell 140. In some example embodiments, the first cell 130 and the second cell 140 can be collocated. For example, the device 120-1 can comprise the first cell 130 and the second cell 140. Alternatively, the first cell and the second cell may not be collocated. For example, the device 120-1 can comprise the first cell 130 and the device 120-2 can comprise the second cell 140. Only for the purpose of illustrations, the device 120-1 can be referred to as the second device and the device 120-2 can be referred to as the third device. It should be noted that the second device and the third device are interchangeable. In some example embodiments, if the cells are collocated, the second device and the third device can be the same device.

Only for the purpose of illustrations, the first cell 130 can be a primary cell (PCell). In some example embodiments, the second cell 140 can be a secondary cell with PUCCH. Alternatively, the second cell 140 can be a primary secondary cell (PSCell). The term “primary cell” used herein can refer to a master cell group (MCG) cell which is operating on the primary frequency, in which the UE either performs the initial connection establishment procedure or initiates the connection re-establishment procedure. The term “secondary cell” used herein can refer to a cell, for a UE configured with CA, providing additional radio resources on top of Special Cell (SpCell). For a UE in RRC_CONNECTED not configured with carrier aggregation (CA)/dual-connectivity (DC), there is only one serving cell comprising of the primary cell. For a UE in RRC_CONNECTED configured with CA/DC, the term “serving cells” is used to denote the set of cells comprising of the Special Cell(s) and all secondary cells. The term

“PSCell” user herein can refer to a primary cell of a secondary cell group (SCG). The term “SpCell” used herein refers to a PCell or a PSCell.

It is to be understood that the number of first devices and cells and their connections shown in FIG. 1 is given for the purpose of illustration without suggesting any limitations. The communication environment 100 may include any suitable number of devices and networks adapted for implementing embodiments of the present disclosure.

Communications in the communication environment 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

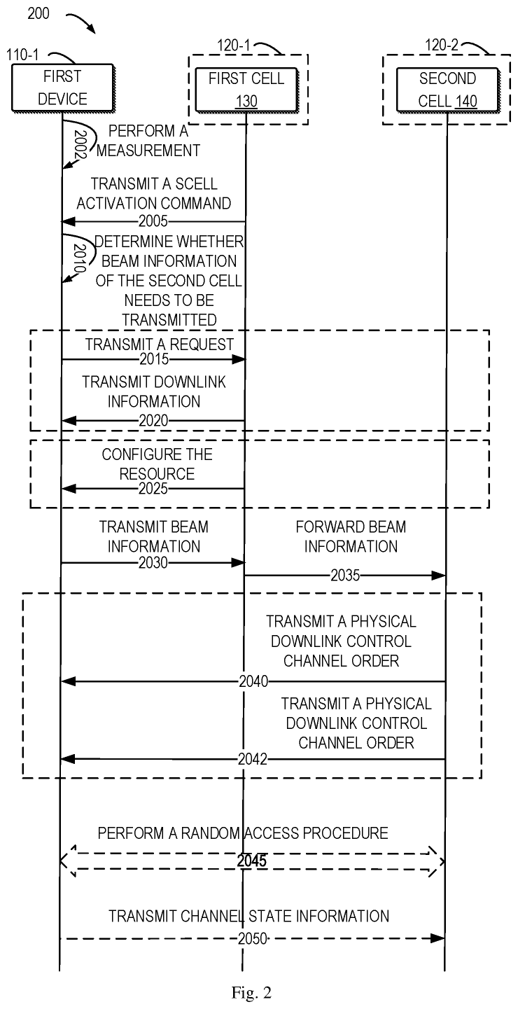

Example embodiments of the present disclosure will be described in detail below with reference to the accompanying drawings. Reference is now made to FIG. 2, which illustrates a signaling flow 200 for delivering beam information according to example embodiments of the present disclosure. For the purpose of discussion, the signaling flow 200 will be described with reference to FIG. 1. Only for the purpose of illustrations, the signaling flow 200 may involve the first device 110-1 and the second device 120. As mentioned above, the first cell 130 and the second cell 140 may be collocated. Alternatively, the first cell 130 and the second cell 140 may not be collocated. Only for the purpose of illustrations, the signaling flow 200 is described with a reference to the scenario where the first cell 130 and the second cell 140 are not collocated, the device 120-1 comprises the first cell 130 and the device 120-2 comprises the second cell 140. In this example, the first cell 130 is PCell and the second cell 140 is PUCCH SCell.

The device 120-2 can transmit a set of reference signal to the first device 110-1. For example, in some example embodiments, the device 120-2 can transmit a reference signal in the second cell 140 to the first device 110-1. For example, the reference signal can be SSB or CSI-RS. In some example embodiments, the first device 110-1 can measure the reference signal and determine the measurement report based on a measurement of the reference signal.

The first device 110-1 can perform 2002 a measurement on the set of reference signals. In some example embodiments, the first device 110-1 can measure reference signal received power (RSRP) on the set of reference signals. In other embodiments, the first device 110-1 can measure reference signal received quality (RSRQ) on the set of reference signals. Alternatively or in addition, the first device 110-1 can obtain received signal strength indicator (RSSI) of the set of reference signals. Based on these measurements and alternatively other measurements, the first device 110-1 may obtain the information needed for the measurement report.

In some example embodiments, the device 120-1 can transmit configuration information which may indicate a measurement configuration. For example, the measurement configuration can comprise one or more of: a reference signal type, a measurement periodicity, a measurement RS transmission period specific to the second cell 140. The measurement configuration can also indicate where to measure the set of reference signals in time domain. Alternatively or in addition, the measurement configuration can also indicate where to measure the second set of reference signals in frequency domain.

The device 120-1 transmits 2005 an activation indication to the first device 110-1 to activate the second cell 140 of the device 120-2. In some embodiments, the activation indication can be transmitted in the first cell 130. Alternatively, the activation indication can be transmitted in other cells. The second cell 140 is configured with PUCCH and the UE shall perform PUCCH transmission on the second cell 140. For example, the activation indication can comprise an identity of the second cell 140. In some example embodiments, the first device 110-1 can be configured with more than one cells. The device 120-1 may configure a SCell and/or a PUCCH SCell in a deactivated state. Alternatively, the device 120-1 may configure a SCell and/or a PUCCH SCell in an activated state. The first device 110-1 can be configured with the information that the second cell 140 can be regarded as the SCell with PUCCH. The activation indication can be transmitted in any proper signaling.

The first device 110-1 determines 2010 whether beam information of the second cell 140 of the device 120-2 needs to be transmitted. The first device 110-1 can determine that the beam information should be transmitted if a condition is fulfilled. In some example embodiments, if the second cell is the first unknown SCell in the FR2 band, the beam information needs to be transmitted. In other embodiments, if the first device has reported beam-specific results and the measured power of the latest reported beam is below a threshold power, the first device 110-1 can determine to transmit the beam information. Alternatively or in addition, if the receive timing difference (RTD) between the first cell 130 and the second cell 140 is no less than a threshold timing difference, the beam information needs to be transmitted. In other words, if the receive timing difference between a downlink signal of the first cell 130 and a downlink signal of the second cell 140 is less than a threshold timing difference, the first cell 130 and the second cell 140 can be regarded as co-located. It should be noted that the conditions for transmitting the beam information are not limited to the above examples. In other embodiments, the first device 110-1 can decide to perform beam search (SSB/CSI measurement) and get ready for the request from the network before PDCCH order reception only if beam information needs to be transmitted. Otherwise, it could start the measurement/report after the PDCCH order reception.

In some example embodiments, if the beam information needs to be transmitted, the first device 110-1 may transmit 2015 a request for a resource in the first cell 130 for transmitting the beam information of the second cell 140. The device 120-1 can transmit 2020 downlink information which indicates the resource. Alternatively, the first device 110-1 may not transmit the request, the device 120-1 can opportunistically schedule the first device 110-1 for transmitting the beam information. In other words, the device 120-1 can transmit the downlink information indicating the resource without the request transmitted by the device 120-1.

In some example embodiments, the device 120-1 can configure 2025 the resource to the first device 110-1. The resource can be configured temporarily only during the activation of the second cell 140. In some example embodiments, the resource can be configured or activated upon the activation indication. For example, the activation indication may indicate the resource. Alternatively, the resource can be configured previously and the resource can be activated upon the activation indication.

In some example embodiments, the resource can be released after the beam information is transmitted to the device 120-1 in the first cell 130. Alternatively, the resource can be reallocated to the second cell 140. In other words, the resource can be switched to the second cell 140 for later use, for example, CSI reporting. In this case, the temporary resource configured in the first cell 130 may start no earlier than a timing of a hybrid automatically repeat request (THARQ) and no later than DL activation time. In this way, there is no impact to the activation delay of the second cell.

The first device 110-1 can transmit 2030 the beam information of the second cell 140 to the device 120-1 on the first cell 130 on the resource. In some example embodiments, the beam information can comprise L1-RSRP or L3 measurement reports for respective beams in the second cell 140. Alternatively, the beam information can indicate an index of a beam which has the best quality based on the measurement. In other embodiments, the beam information can comprise at least an index of SSB of the beam which has the best quality.

In some example embodiments, after the first device 110-1 has acquired DL timing and performed the measurement, the first device 110-1 can transmit the beam information on the resource. In order to minimize the impact to activation delay, the first device 110-1 is assumed to have acquired the UL resource for transmitting the beam information in the first cell 130 no later than the DL activation time. In other words, the request (transmitted at 2015) and the resource allocation in first cell 130 can be done in parallel with the DL synchronization and the measurement in the second cell 140.

After the device 120-1 receives the beam information, the device 120-1 can forward 2035 the beam information to the device 120-2. The device 120-2 can determine a beam based on the beam information. For example, as mentioned above, the beam information can comprise the L1-RSRP measurement reports for respective beams, the device 120-2 can select the beam based on the L1-RSRP reports. Alternatively, if the beam information comprises an index of SSB of the beam which has the best quality, the device 120-2 can select the corresponding beam.

In other embodiments, the first device 110-1 can decide to perform beam search (SSB/CSI measurement) and get ready for the request from the network before PDCCH order reception only if beam information needs to be transmitted.

In other embodiments, the device 120-2 may transmit the PDCCH order on any of the beams until the first device 110-1 responds. For example, as shown in FIG. 2, the device 120-2 can transmit 2040 the PDCCH order to the first device 110-1 in a beam associated with the first SSB. The device 120-2 can transmit 2042 the PDCCH order to the first device 110-1 in a beam associated with the second SSB until the first device 110-1 responds to the PDCCH order. The term “PDCCH order” used herein can refer to a mechanism by which a network device informs a terminal device to initiate a physical random access channel (PRACH). PDCCH order is a signaling and it can be used to bring back uplink out-of-sync UE) back to in-sync state in case there is downlink data available for it. In some embodiments, the PDCCH order can be transmitted in all beams to trigger the random access. In this situation, if the first device 110-1 determines beam information is not available in the PDCCH order (or rather the PDCCH order does not tell the first device 110-1 which RACH occasion to use to transmit the PRACH preamble), the first device 110-1 may initiate the RACH procedure on the best beam known to the first device 110-1. The process could trigger L1-RSRP measurement at this stage, or the best beam may be known to the first device 110-1 in advance. The network would implicitly know the beam information upon detecting the RA preamble from the RACH occasion used to transmit it.

For example, the first device 110-1 is able to receive a PDCCH order that is transmitted in a beam where the UE is monitoring. The first device 110-1 can transmit a response on the best SSB beam measured by the first device 110-1. The first device 110-1 can further only respond to the PDCCH order that carried the SSB index (more specifically a RACH occasion that is associated with the SSB) of the best SSB as measured by the first device 110-1, or it can respond to the best known beam it measures regardless of any beam indication in the PDCCH order. The response means that upon reception of the PDCCH order, the first device 110-1 can perform 2045 contention-free RA on the PRACH resources associated with the selected beam.

In some example embodiments, the first device 110-1 can perform 2045 a contention free random access procedure with the device 120-2. Alternatively, if the first device 110-1 has valid TA in the second cell 140, the first device 110-1 has the UL timing hence no random access procedure is needed. But still the network may need to understand the beam information in order to indicate PDCCH/PDSCH TCI so that the network knows which DL beam the UE is monitoring in the second cell 140 and that the first device 110-1 can monitor the proper DL beam in the second cell 140. After the first device 110-1 has received TCI activation command, it can monitor the beam and report CSI in the second cell 140. The TCI activation command can indicate an index of an uplink beam which is determined based on the beam information. The first device 110-1 can perform the random access procedure on the uplink beam.

In some example embodiments, the first device 110-1 can generate a CSI report based on measurements of reference signals. In wireless communications, the term “channel state information (CSI)” refers to known channel properties of a communication link. This information describes how a signal propagates from the transmitter to the receiver and represents the combined effect of, for example, scattering, fading, and power decay with distance.

The first device 110-1 can transmit 2050 a CSI report to the device 120-2. In some example embodiments, the device 120-2 can transmit the CSI report in the second cell 140. Alternatively, if the beam information has been transmitted, the first device 110-1 may not need to transmit the CSI report.

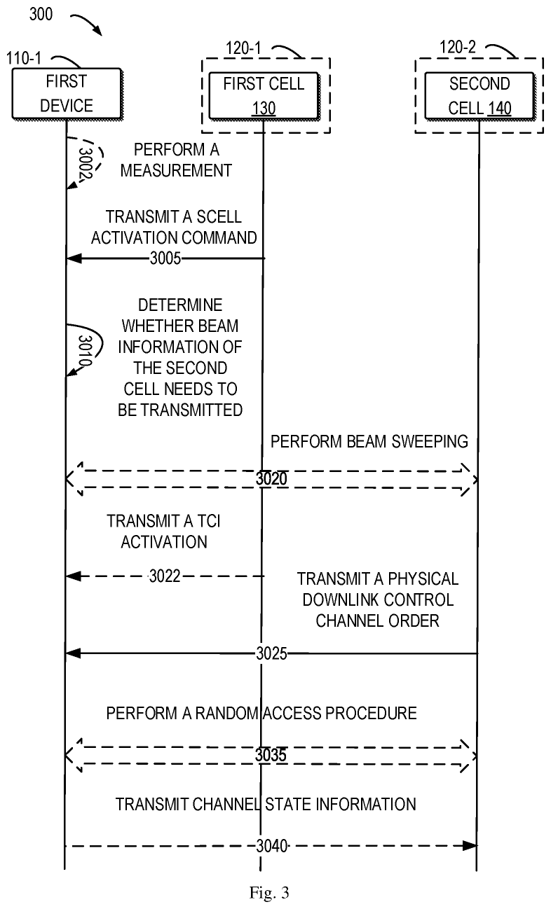

FIG. 3 illustrates a signaling flow 300 for delivering beam information according to some other example embodiments of the present disclosure. For the purpose of discussion, the signaling flow 300 will be described with reference to FIG. 1. Only for the purpose of illustrations, the signaling flow 300 may involve the first device 110-1 and the second device 120. As mentioned above, the first cell 130 and the second cell 140 may be collocated. Alternatively, the first cell 130 and the second cell 140 may not be collocated. Only for the purpose of illustrations, the signaling flow 200 is described with a reference to the scenario where the first cell 130 and the second cell 140 are not collocated, the second device 120-1 comprises the first cell 130 and the third device 120-2 comprises the second cell 140.

The device 120-2 can transmit a set of reference signal to the first device 110-1. For example, in some example embodiments, the device 120-2 can transmit a reference signal in the second cell 140 to the first device 110-1. For example, the reference signal can be SSB or CSI-RS. In some example embodiments, the first device 110-1 can measure the reference signal and determine the measurement report based on a measurement of the reference signal.

The first device 110-1 can perform 3002 a measurement on the set of reference signals. In some example embodiments, the first device 110-1 can measure reference signal received power (RSRP) on the set of reference signals. In other embodiments, the first device 110-1 can measure reference signal received quality (RSRQ) on the set of reference signals. Alternatively or in addition, the first device 110-1 can obtain received signal strength indicator (RSSI) of the set of reference signals. Based on these measurements and alternatively other measurements, the first device 110-1 may obtain the information needed for the measurement report.

In some example embodiments, the device 120-1 can transmit configuration information which may indicate a measurement configuration. For example, the measurement configuration can comprise one or more of: a reference signal type, a measurement periodicity, a measurement RS transmission period specific to the second cell 140. The measurement configuration can also indicate where to measure the set of reference signals in time domain. Alternatively or in addition, the measurement configuration can also indicate where to measure the second set of reference signals in frequency domain.

The device 120-1 transmits 3005 an activation indication to the first device 110-1 to activate the second cell 140 of the device 120-2. In some embodiments, the activation indication can be transmitted in the first cell 130. Alternatively, the activation indication can be transmitted in other cells. The second cell 140 is configured with PUCCH and the UE can perform PUCCH transmission on the second cell 140. For example, the activation indication can comprise an identity of the second cell 140. In some example embodiments. the first device 110-1 can be configured with more than one cells. The device 120-1 may configure a SCell and/or a PUCCH SCell in a deactivated state. Alternatively, the device 120-1 may configure a SCell and/or a PUCCH SCell in an activated state. The first device 110-1 can be configured with the information that the second cell 140 can be regarded as the SCell with PUCCH. The activation indication can be transmitted in any proper signaling.

The first device 110-1 determines 3010 whether beam information of the second cell 140 of the device 120-2 needs to be transmitted. The first device 110-1 can determine that the beam information should be transmitted if a condition is fulfilled. In some example embodiments, if the second cell is the first unknown SCell in the FR2 band, the beam information needs to be transmitted. In other embodiments, if the first device has reported beam-specific results and the measured power of the latest reported beam is below a threshold power, the first device 110-1 can determine to transmit the beam information. Alternatively or in addition, if the receiving timing difference between the first cell 130 and the second cell 140 is no less than a threshold timing difference, the beam information needs to be transmitted. It should be noted that the conditions for transmitting the beam information are not limited to the above examples.

In some embodiments, if the first device 110-1 determines there is no need to transmit beam information, the first device 110-1 can check SSB availability. For example, the device 120-2 can perform 3020 beam sweeping. The term “beam sweeping” used herein refers to a technique to transmit the beams in all predefined directions in a burst in a regular interval. Only as an example, if there are 32 beams, the device 120-2 can transmit 32 SS blocks in different predefined beams. The set of directions covered by the SS blocks may or may not cover entire set of predefined directions.

Alternatively, if the first device 110-1 determines that there is no need to transmit the beam information, the device 120-2 can determine the beam information of the second cell based on the beam information of the first cell or any of the active cells. Alternatively, the device 120-2 can determine the beam information based on the latest reported beam index. For example, the device 120-2 can assume the same beam information with the first cell or reuse the latest reported beam. In some example embodiments, the device 120-2 may transmit 3022 the PDCCH TCI activation command assuming the same beam information with the first cell or reusing the latest reported beam. In this case, the device 120-2 can transmit the PDCCH order indicating the SSB index.

The first device 110-1 can accordingly perform 3035 the RA on the PRACH resources associated with the signaled SSB and transmit 3040 CSI report on the second cell 140 after RACH. Alternatively, the device 120-1 can transmit 3030 the PDCCH TCI activation to the first device 110-1 after the PDCCH order based on the UE response to the selected beam. In other embodiments, the activation delay can be minimized considering different UE behaviors on beam information transmission. For example, if beam information transmission is not required, the activation delay is defined assuming no L1-RSRP measurements in FR2. Alternatively, if the beam information transmission is required, the activation delay is defined assuming the first device 110-1 has transmitted the beam information no later than DL activation delay (this is to avoid extending the activation period due to beam info transmission).

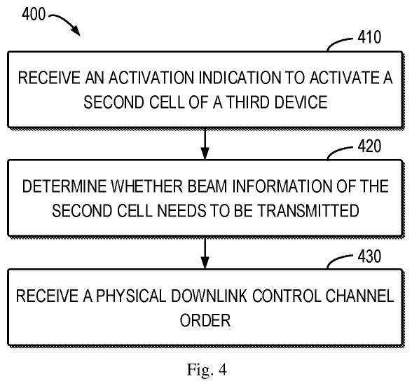

FIG. 4 shows a flowchart of an example method 400 in accordance with some example embodiments of the present disclosure. For the purpose of discussion, the method 400 will be described from the perspective of the device 110. Only for the purpose of illustrations, the method 400 is described with the reference to the device 110-1.

At block 410, the first device 110-1 receives, from a second device, an activation indication to activate a second cell 140 of a third device. For example, the first cell is a primary cell and the second cell is a secondary cell configured with physical uplink control channel. If the first cell 130 and the second cell 140 may be collocated, the second device and the third device can be the same device. Alternatively, if the first cell 130 and the second cell 140 may not be collocated, the second device and the third device can be different devices.

At block 420, the first device 110-1 determines whether beam information of the second cell 140 needs to be transmitted. If at least one condition for transmitting the beam information is fulfilled, the first device 110-1 can determine that the beam information of the second cell 140 needs to be transmitted. In some examples, the condition can comprise that the second cell is an unknown cell in frequency range 2 band. Alternatively, the condition may be that reference signal received power of a latest reported beam index is smaller than a threshold power. In other embodiments, the condition may comprise that a receive timing difference (RTD) between the first cell and the second cell is no less than a threshold timing difference.

In some example embodiments, the first device 110-1 can determine a resource in the first cell 130 for transmitting the beam information based on downlink control information from the second device. For example, the first device 110-1 can transmit a request for the resource to transmit the beam information in the second device. The first device 110-1 can receive the downlink control information indicating the resource. The downlink control information can be transmitted without the request. Alternatively, the first device 110-1 can determine the resource based on the activation indication. For example, the second device can configure temporary resource in the second cell to the first device 110-1. In this case, the temporary resource can be activated based on the activation indication.

In some example embodiments, the first device 110-1 can transmit, to the second device, the beam information of the second cell 140 on the resource in the first cell 130. The first device 110-1 can release the resource after a transmission of the beam information. Alternatively, the first device 110-1 can reallocate the resource to the second cell 140.

At block 430, the first device 110-1 receives a physical downlink control channel order from the third device to perform the random access procedure to the device 120-2. In some embodiments, the PDCCH order can be transmitted on the second cell 140. Alternatively, the PDCCH order can be transmitted on other cells, for example, a PCell. For example, the first device 110-1 can receive the physical downlink control channel order in the beam which is determined on the beam information.

In some example embodiments, the first device 110-1 can perform a contention-free random access procedure on the second cell 140 in the beam which is indicated in the physical downlink control channel order or which is determined based on a measurement on the second cell.

In an example embodiment, if the beam information of the second cell 140 needs to be transmitted, the first device 110-1 can perform a measurement on all the beams on the second cell 140 before the reception of the physical downlink control channel order. Alternatively, if the beam information of the second cell 140 does not need to be transmitted, the measurement on all the beams of the second cell 140 can be skipped or delayed. In other embodiments, the first device 110-1 can perform the measurement on all the beams on the second cell 140 after the reception of the physical downlink control channel order.

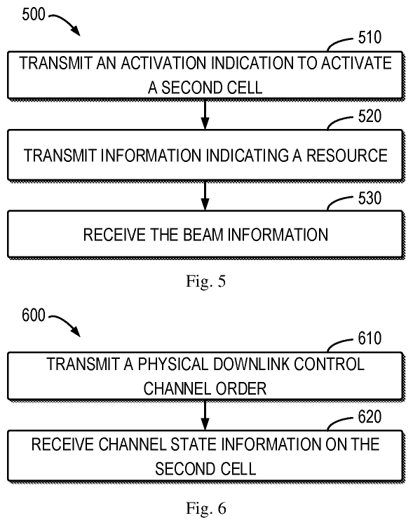

FIG. 5 shows a flowchart of an example method 500 in accordance with some example embodiments of the present disclosure. For the purpose of discussion, the method 500 will be described from the perspective of the second device. Only for the purpose of illustrations, the second device can be the device 120-1.

At block 510, the device 120-1 transmits, to a first device 110-1, an activation indication to activate a second cell 140 of a third device (for example, the device 120-2). For example, the first cell is a primary cell and the second cell is a secondary cell configured with physical uplink control channel.

At block 520, the device 120-1 transmits, to a first device 110-1, information indicating a resource in the first cell 130 for transmitting beam information of a second cell 140 of a third device by the first device 110-1. In some example embodiments, if the device 120-1 receives a scheduling request for the resource from the first device 110-1, the device 120-1 can transmit the information to the first device 110-1. Alternatively, the device 120-1 can opportunistically schedule the first device 110-1 and transmit the information to the first device 110-1. In other embodiments, the resource can be transmitted in the activation of the second cell 140.

At block 530, the device 120-1 receives, from the first device 110-1, the beam information of the second cell 140 of the third device on the first cell 130. In some example embodiments, the device 120-1 can forward the beam information of the second cell of the third device.

FIG. 6 shows a flowchart of an example method 600 in accordance with some example embodiments of the present disclosure. For the purpose of discussion, the method 600 will be described from the perspective of the device 120. Only for the purpose of illustrations, the second device can be the device 120-2.

At block 610, the device 120-2 transmits, to a first device 110-1, a physical downlink control channel order on a second cell 140 of the third device in at least one beam which is selected in association with beam information of the second cell 140. In some example embodiments, the device 120-2 can transmit the physical downlink control channel order in a plurality of beams. Alternatively, the device 120-2 can determine a beam based on at least one of: beam information of the second cell 140 of the third device which is received from the second device, or a latest reported beam index, or the measurement reports on each of the beams. In this case, the device 120-2 can transmit the physical downlink control channel order in the beam.

At block 620, the device 120-2 receives, from the first device 110-1, channel state information on the second cell 140. The device 120-2 can perform a contention-free random access procedure on the second cell in the beam which is indicated in the physical downlink control channel order or which is determined based on a measurement on the second cell.

In some example embodiments, a first apparatus capable of performing any of the method 400 (for example, the first device 110) may comprise means for performing the respective operations of the method 400. The means may be implemented in any suitable form. For example, the means may be implemented in a circuitry or software module. The first apparatus may be implemented as or included in the first device 110. In some example embodiments, the means may comprise at least one processor and at least one memory including computer program code. The at least one memory and computer program code are configured to, with the at least one processor, cause performance of the apparatus.

In some example embodiments, the apparatus comprises means for receiving, from a second device, an activation indication to activate a second cell of a third device; means for determining whether beam information of the second cell needs to be transmitted to the second device on a first cell of the second device; and means for receiving a physical downlink control channel order from the third device to perform a random access procedure to the third device.

In some example embodiments, the first cell is a primary cell or a primary secondary cell, the second cell is a secondary cell configured with physical uplink control channel, and the second device and the third device are same or different devices.

In some example embodiments, the means for determining whether the beam information of the second cell needs to be transmitted comprises: means for determining that the beam information of the second cell needs to be transmitted, in accordance with a determination that at least one of following conditions is fulfilled: the second cell is an unknown cell, a reference signal received power of a latest reported beam is smaller than a threshold power, or a receive timing difference between the first cell and the second cell is no less than a threshold timing difference.

In some example embodiments, the apparatus comprises means for receiving, from the second device, downlink control information indicating a resource in the first cell for transmitting the beam information; and means for transmitting, to the second device, the beam information of the second cell on the resource in the first cell.

In some example embodiments, the apparatus comprises means for transmitting, to the second device, a scheduling request for the resource in the first cell for transmitting the beam information.

In some example embodiments, the apparatus comprises means for releasing the resource after a transmission of the beam information; or means for reallocating the resource to the second cell.

In some example embodiments, the means for receiving the physical downlink control channel order comprises: means for receiving the physical downlink control channel order in the beam which is determined based on the beam information.

In some example embodiments, the apparatus comprises means for performing a contention-free random access procedure on the second cell in the beam which is indicated in the physical downlink control channel order or which is determined based on a measurement on the second cell.

In some example embodiments, the apparatus comprises means for in accordance with a determination that the beam information of the second cell needs to be transmitted, performing a measurement on the second cell before the reception of the physical downlink control channel order; or means for in accordance with a determination that the beam information of the second cell does not need to be transmitted, causing the measurement on the second cell to be skipped; or performing the measurement on the second cell after the reception of the physical downlink control channel order.

In some example embodiments, a second apparatus capable of performing any of the method 500 (for example, the second device) may comprise means for performing the respective operations of the method 500. The means may be implemented in any suitable form. For example, the means may be implemented in a circuitry or software module. The second apparatus may be implemented as or included in the second device. In some example embodiments, the means may comprise at least one processor and at least one memory including computer program code. The at least one memory and computer program code are configured to, with the at least one processor, cause performance of the apparatus.

In some example embodiments, the apparatus comprises means for transmitting, to a first device, an activation indication to activate a second cell of a third device; means for transmitting, to the first device, information indicating a a in the first cell for transmitting beam information of a second cell of a third device by the first device; and means for receiving, from the first device, the beam information of the second cell of the third device on the first cell.

In some example embodiments, the first cell is a primary cell or a primary secondary cell, the second cell is a secondary cell configured with physical uplink control channel, and the second device and the third device are same or different devices.

In some example embodiments, the means for transmitting the information indicating the resource in the first cell comprises: means for transmitting the information indicating the resource based on at least one of: a scheduling request for the resource from the first device, a schedule of the first device, or the activation of the second cell.

In some example embodiments, the apparatus comprises means for transmitting, to the third device, the beam information of the second cell of the third device.

In some example embodiments, a third apparatus capable of performing any of the method 600 (for example, the device 120-2) may comprise means for performing the respective operations of the method 600. The means may be implemented in any suitable form. For example, the means may be implemented in a circuitry or software module. The third apparatus may be implemented as or included in the device 110-2. In some example embodiments, the means may comprise at least one processor and at least one memory including computer program code. The at least one memory and computer program code are configured to, with the at least one processor, cause performance of the apparatus.

In some example embodiments, the apparatus comprises means for transmitting, to a first device, a physical downlink control channel order in at least one beam which is selected in association with beam information of the second cell; and means for receiving, from the first device, channel state information on the second cell.

In some example embodiments, the means for transmitting the physical downlink control channel order comprises: means for transmitting the physical downlink control channel order in a plurality of beams.

In some example embodiments, the means for transmitting the physical downlink control channel order comprises: means for determining a beam based on at least one of: beam information of the second cell of the third device which is received from the second device, or a latest reported beam index; and means for transmitting the physical downlink control channel order in the beam.

In some example embodiments, the apparatus comprises means for performing a contention-free random access procedure on the second cell in the beam which is indicated in the physical downlink control channel order or which is determined based on a measurement on the second cell.

In some example embodiments, the apparatus comprises means for in accordance with a determination that the beam information is not transmitted by the first device, determining the beam information of the second cell based on beam information of the first cell or a latest reported beam index.

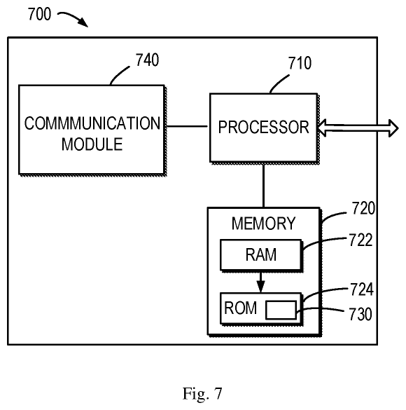

FIG. 7 is a simplified block diagram of a device 700 that is suitable for implementing example embodiments of the present disclosure. The device 700 may be provided to implement a communication device, for example, the first device 110 or the second device 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not latest in the power-down duration.

A computer program 730 includes computer executable instructions that are executed by the associated processor 710. The program 730 may be stored in the memory. e.g., ROM 724. The processor 710 may perform any suitable actions and processing by loading the program 730 into the RAM 722.

Example embodiments of the present disclosure may be implemented by means of the program 730 so that the device 700 may perform any process of the disclosure as discussed with reference to FIGS. 2 to 6. The example embodiments of the present disclosure may also be implemented by hardware or by a combination of software and hardware.

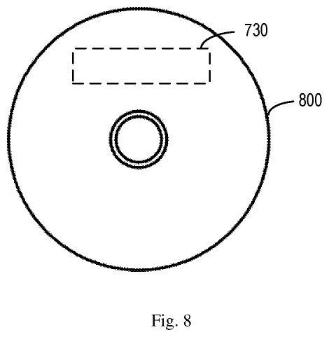

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and other magnetic storage and/or optical storage. FIG. 8 shows an example of the computer readable medium 800 in form of an optical storage disk. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target physical or virtual processor, to carry out any of the methods as described above with reference to FIGS. 3 to 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-39. (canceled)

40. A first device, comprising:
at least one processor; and
at least one memory including computer program code;
wherein the at least one memory and the computer program code are configured to, with the at least one processor, cause the first device to perform:
receiving, from a second device, an activation indication to activate a second cell of a third device;
determining whether beam information of the second cell needs to be transmitted to the second device on a first cell of the second device, wherein determining whether the beam information of the second cell needs to be transmitted comprises:
determining that the beam information of the second cell needs to be transmitted, in accordance with a determination that at least one of following conditions is fulfilled:
the second cell is an unknown cell,
a reference signal received power of a latest reported beam is smaller than a threshold power, or
a receive timing difference between the first cell and the second cell is no less than a threshold timing difference; and
receiving a physical downlink control channel order from the third device to perform a random access procedure to the third device, wherein the physical downlink control channel order is received in the beam which is determined based on the beam information.

41. The first device of claim 40, wherein the first cell is a primary cell or a primary secondary cell, the second cell is a secondary cell configured with physical uplink control channel, and the second device and the third device are same or different devices.

42. The first device of claim 40, further caused to perform:
receiving, from the second device, downlink control information indicating a resource in the first cell for transmitting the beam information; and
transmitting, to the second device, the beam information of the second cell on the resource in the first cell.

43. The first device of claim 42, further caused to perform:
transmitting, to the second device, a scheduling request for the resource in the first cell for transmitting the beam information.

44. The first device of claim 42, further caused to perform:
releasing the resource after a transmission of the beam information; or
reallocating the resource to the second cell.

45. The first device of claim 40, further caused to perform:
performing a contention-free random access procedure on the second cell in the beam which is indicated in the physical downlink control channel order or which is determined based on a measurement on the second cell.

46. The first device of claim 40, further caused to perform:
in accordance with a determination that the beam information of the second cell needs to be transmitted, performing a measurement on the second cell before the reception of the physical downlink control channel order; or
in accordance with a determination that the beam information of the second cell does not need to be transmitted, causing the measurement on the second cell to be skipped; or
performing the measurement on the second cell after the reception of the physical downlink control channel order.

47. A second device, comprising:
at least one processor; and
at least one memory including computer program code;
wherein the at least one memory and the computer program code are configured to, with the at least one processor, cause the second device to perform:
transmitting, to a first device, an activation indication to activate a second cell of a third device;
transmitting, to the first device, information indicating a resource in a first cell for transmitting beam information of a second cell of a third device by the first device; and
receiving, from the first device, the beam information of the second cell of the third device on the first cell.

48. The second device of claim 47, wherein the first cell is a primary cell or a primary secondary cell, the second cell is a secondary cell configured with physical uplink control channel, and the second device and the third device are same or different devices.

49. The second device of claim 47, wherein transmitting the information indicating the resource in the first cell comprises:
transmitting the information indicating the resource based on at least one of:
a scheduling request for the resource from the first device,
a schedule of the first device, or
the activation of the second cell.

50. The second device of claim 47, further caused to perform:
transmitting, to the third device, the beam information of the second cell of the third device.

51. A third device, comprising:
at least one processor; and
at least one memory including computer program code;
wherein the at least one memory and the computer program code are configured to, with the at least one processor, cause the third device to perform:
transmitting, to a first device, a physical downlink control channel order in at least one beam which is selected in association with beam information of a second cell of the third device; and
receiving, from the first device, channel state information on the second cell.

52. The third device of claim 51, wherein transmitting the physical downlink control channel order comprises:
transmitting the physical downlink control channel order in a plurality of beams.

53. The third device of claim 51, wherein transmitting the physical downlink control channel order comprises:
determining a beam based on at least one of:
beam information of the second cell of the third device which is received from the second device, or a latest reported beam index; and
transmitting the physical downlink control channel order in the beam.

54. The third device of claim 51, further caused to perform:
performing a contention-free random access procedure on the second cell in the beam which is indicated in the physical downlink control channel order or which is determined based on a measurement on the second cell.

55. The third device of claim 51, further caused to perform:
in accordance with a determination that the beam information is not transmitted by the first device, determining the beam information of the second cell based on beam information of the first cell or a latest reported beam index.
